(19) United States
(12) Patent Application Publication
(10) Pub. No.: US 2009/0262435 A1
(43) Pub. Date: Oct. 22, 2009

(54) Optical driving apparatus using electro-wetting and driving method of the same

(75) Inventors: Ju Ho Kim, Yonin (KR); Dong Jin Kim, Gwangmeyong (KR); Dong Ik Shin, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/292,277

(22) Filed: Nov. 14, 2008

(30) Foreign Application Priority Data
Apr. 18, 2008 (KR) 10-2008-0036117

(51) Int. Cl. G02B 3/12

(52) U.S. Cl. 359/665

(57) ABSTRACT

There is provided an optical driving apparatus including: a cell housing housing polar and non-polar liquids, the cell housing including side walls; a first electrode formed on an outer surface of a first insulator formed on a portion of one of the side walls of the cell housing; a second electrode formed on an outer surface of a second insulator formed on a portion of the other side wall of the cell housing; a color filter formed on a top of the cell housing; and a third electrode formed on a bottom of the cell housing to be in contact with the polar liquid so that the third electrode generates a potential in the polar liquid together with one of the first and second electrodes, wherein light incident from a light source unit disposed below the third electrode is irradiated onto a predetermined area of the color filter.

### CROSS-REFERENCE TO RELATED APPLICATIONS

This application claims the priority of Korean Patent Application No. 2008-36117 filed on Apr. 18, 2008, in the Korean Intellectual Property Office, the disclosure of which is incorporated herein by reference.

### BACKGROUND OF THE INVENTION

1. Field of the Invention

The present invention relates to an optical driving apparatus using electro-wetting and a driving method of the same, and more particularly, to an optical driving apparatus capable of controlling a light incidence area using electrowetting, and a driving method of the same.

2. Description of the Related Art

Electrowetting is derived from the electrocapillary phenomenon, in which surface tension of an interface is changed due to charges present at the interface to change a contact angle. Particularly, in the case of electrowetting, a thin film insulator exists at the interface to increase a potential difference.

This electrowetting is based on the fact that water droplets, when applied with an electric field, spread. This phenomenon was unearthed in 1990es when an attempt was made to solve the problem that electrocapillary no longer occurs with an increase involtage. That is, electrowetting, which is based on the electrocapillary phenomenon that surface tension can be changed by electricity, allows the surface tension to be controlled at a high voltage by interposing a thin insulator of a nano meter thickness between water and metal.

An apparatus using this electro-wetting is illustrated as a display apparatus shown in FIG. 1. This conventional display apparatus 10 includes a closed cell 3, immiscible polar liquid 1 and non-polar liquid 2 housed in the closed cell 3 to have different optical properties, an upper electrode 6, at least one pair of electrodes including an address electrode 4 and a sustain electrode 5.

The address electrode 4 and the sustain electrode 5 are separated from the liquids 1 and 2 from a surface 7 having weak affinity to one of the liquids. The address electrode 4 and the sustain electrode 5 have voltages applied thereto, respectively so as to control spatial distribution of the liquids 1 and 2 together with the upper electrode 6. The voltage applied in this fashion allows light passing through the liquids 1 and 2 to be transmitted to the outside or blocked.

However, this conventional display apparatus using electrowetting suffers loss in a portion of light incident on the liquids 1 and 2 when light passing through the liquids 1 and 2 is transmitted or blocked. Accordingly, this degrades light efficiency of the display apparatus.

### SUMMARY OF THE INVENTION

An aspect of the present invention provides an optical driving apparatus capable of controlling a light incidence area using electrowetting in order to overcome light loss when the light is transmitted or blocked, and a driving method of the same.

According to an aspect of the present invention, there is provided an optical driving apparatus including: a cell housing housing a polar liquid and a non-polar liquid, the cell housing including side walls; a first electrode formed on an outer surface of a first insulator formed on a portion of one of the side walls of the cell housing; a second electrode formed on an outer surface of a second insulator formed on a portion of the other side wall of the cell housing; a color filter formed on a top of the cell housing; and a third electrode formed on a bottom of the cell housing to be in contact with the polar liquid so that the third electrode generates a potential in the polar liquid together with one of the first and second electrodes, wherein light incident from a light source unit disposed below the third electrode is irradiated onto a predetermined area of the color filter.

The optical driving apparatus may further include at least one variable voltage device electrically connected to one of the first and second electrodes, wherein an interface between the polar liquid and the non-polar liquid is changed by the third electrode together with one of the first and second electrodes to which a voltage controlled by the variable voltage device is applied.

The cell housing may have the side walls formed of a light blocking material and the bottom formed of a light transmitting material.

Each of the first and second electrodes may be configured as a rectangular metal electrode formed on an outer side of the insulator along a corresponding one of the side walls of the cell housing.

The third electrode may be formed of a transparent electrode material selected from a group consisting of ITO, ZnO, RuO₂, TiO₂ and IrO₂.

The variable voltage device may be a variable resistor.

According to another aspect of the present invention, there is provided a method of driving an optical driving apparatus, the method including: applying a voltage to one of first and second electrodes formed to oppose each other on both side walls of a cell housing, respectively, the cell housing housing a polar liquid and a non-polar liquid; generating a potential in the polar liquid by a third electrode together with the voltage applied to one of the first and second electrodes, the third electrode formed on a bottom of the cell housing to be in contact with the polar liquid; and irradiating light incident from a light source unit disposed below the third electrode onto a predetermined area of a color filter formed on a top of the cell housing by changing an interface between the polar liquid and the non-polar liquid according to the potential.

The applying a voltage may include forming the first and second electrodes on the both side walls of the cell housing to oppose each other, wherein insulators are formed between each of the first and second electrodes and the cell housing, respectively.

The applying a voltage may include applying the voltage controlled by at least one variable voltage device electrically connected to one of the first and second electrodes.

The irradiating light incident onto a predetermined area of a color filter may include focusing and irradiating the light incident from the light source unit onto the predetermined area of the color filter through the changed interface between the non-polar liquid and the polar liquid.

In the irradiating of the light incident onto the predetermined area of the color filter, the changed interface between the non-polar liquid and the polar liquid may be curved upward toward the color filter and an irradiation angle of the light irradiated onto the predetermined area of the color filter satisfies following Equations 3 and 4, respectively,

$$\begin{matrix}{φ}_{3} = {φ}_{2} - {φ}_{1} = {sin}^{- 1} ( \frac{{n}_{1}}{{n}_{2}} sin ( {φ}_{1} ) ) - {φ}_{1} , & Equation 3 \\ tan {φ}_{3} = \frac{x}{y} , & Equation 4\end{matrix}$$

where φ1 is an angle between the side walls of the cell housing and a perpendicular normal line of the interface, φ2 is a refraction angle of light irradiated onto the predetermined area of the color filter with respect to the perpendicular normal line of the interface, φ3 is an irradiation angle of light refracted to a light irradiation area with respect to the side walls of the cell housing, n, is a refractivity of the polar liquid, n₂ is a refractivity of the non-polar liquid, x is a length from the side walls of the cell housing to the light irradiation area of the color filter, and y is a length from the light irradiation area to the interface between the non-polar liquid and the polar liquid on the side walls of the cell housing.

In the irradiating of the light incident onto the color filter, the changed interface between the non-polar liquid and the polar liquid may be curved upward toward the third electrode and an irradiation angle of the light irradiated onto the predetermined area of the color filter satisfies following Equation 5,

$${φ}_{3} = {φ}_{1} - {φ}_{2} = {φ}_{1} - {sin}^{- 1} ( \frac{{n}_{1}}{{n}_{2}} sin ( {φ}_{1} ) ) , \qquad Equation 5$$

where φ1 is an angle between the side walls of the cell housing and a perpendicular normal line of the interface, φ2 is a refraction angle of light irradiated onto the predetermined area of the color filter with respect to the perpendicular normal line of the interface, φ3 is an irradiation angle of light refracted to a light irradiation area with respect to the side walls of the cell housing, n, is a refractivity of the polar liquid, n₂ is a refractivity of the non-polar liquid.

The irradiating light incident onto a predetermined area of a color filter may include irradiating the light incident from the light source unit onto an entire area of the color filter by flattening the changed interface between the polar liquid and the non-polar liquid.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating an example of a conventional display apparatus using electrowetting;

FIG. 2 is a configuration view illustrating an optical driving apparatus using electrowetting according to an exemplary embodiment of the invention;

FIGS. 3A to 3E are explanatory views illustrating a driving principle of an optical driving apparatus using electrowetting according to an exemplary embodiment of the invention;

FIGS. 4A to 4D illustrate a driving process of an optical driving apparatus using electrowetting according to an exemplary embodiment of the invention;

FIG. 5 is a circuit diagram illustrating arrangement of optical driving apparatuses using electrowetting according to an exemplary embodiment of the invention; and

FIG. 6 illustrates a display apparatus employing an optical driving apparatus using electrowetting according to an exemplary embodiment of the invention.

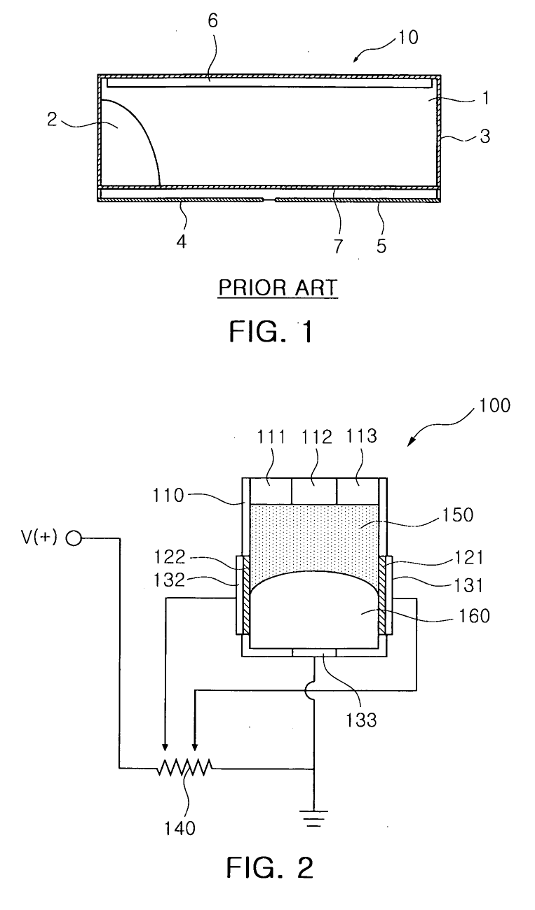

### DETAILED DESCRIPTION OF THE PREFERRED EMBODIMENT

Exemplary embodiments of the present invention will now be described in detail with reference to the accompanying drawings.

FIG. 2 is a configuration view illustrating an optical driving apparatus using electrowetting according to an exemplary embodiment of the invention.

As shown in FIG. 2, the optical driving apparatus 100 using electrowetting according to the present embodiment includes a cell housing 110, a first electrode 131, a second electrode 132, color filters 111, 112, and 113, and a third electrode 133. The cell housing 110 houses a polar liquid 160 and a non-polar liquid 150 and includes side walls. The first electrode 131 is formed on an outer surface of a first insulator 121 formed on a portion of one of the side walls of the cell housing 110. The second electrode 122 is formed on an outer surface of a second insulator 122 formed on a portion of the other side wall of the cell housing 110. The color filters 111, 112, and 113 are formed on a top of the cell housing 110. The third electrode 133 is formed on a bottom of the cell housing 110 to be in contact with the polar liquid 160 so that the third electrode 133 generates a potential in the polar liquid 160 together with the first and second electrodes 131 and 132.

The cell housing 110 is shaped as a rectangular parallelepiped including side walls made of a material blocking light, the bottom made of a light transmitting material, and the top having the red color, green color, blue color filters 111, 112, and 113 installed thereon. The cell housing 110 sealably houses the polar liquid 160 formed of an electrically conductive electrolytic liquid and the non-polar liquid 150 formed of an electrically insulating oil such as silicon oil.

The side walls of the cell housing 110 are formed of a light blocking material and thus block light incident from the outside, or prevent light generated inside from being emitted sideward other than upward. In addition, the cell housing 110 has the bottom formed of a light transmitting material to transmit light incident from a light source unit 170 described later.

The first electrode 131 and the second electrode 132 are formed on the side walls of the cell housing 100, respectively. More specifically, the first and second electrodes 131 and 132 are formed on the first and second insulators 121 and 122 formed on the side walls of the cell housing 110, respectively such that the insulators are disposed between each of the first and second electrodes and the cell housing, respectively. The first and second electrodes 131 and 132 each are configured as a rectangular-shaped metal electrode formed on outer surfaces of the first and second insulators 121 and 122 along the side walls of the cell housing 110, respectively to include an interface between the non-polar liquid 150 and the polar liquid 160.

The third electrode 133 is a transparent electrode formed integrally on a portion of the bottom of the cell housing 110 to be in contact with the polar liquid. For example, the third electrode 133 may be formed of one material selected from ITO, ZnO, RuO₂, TiO₂, and IrO₂.

A potential is generated in the polar liquid 160 by the third electrode 133 together with voltages applied to the first and second electrodes 131 and 132 formed on the side walls of the cell housing 110. Accordingly, this changes an interface between the non-polar liquid 150 and the polar liquid 160.

Here, the voltages applied to the first electrode 131 and the second electrode 132 are controlled by a variable voltage device such as an electrically connected variable resistor 140, respectively. These controlled voltages are applied to the first electrode 131 and the second electrode 132 at a level identical to or different from each other, respectively. Accordingly, a potential is generated in the polar liquid 160 by the third electrode 133 together with the voltages applied to the first and second electrodes 131 and 132.

In the optical driving apparatus 100 according to the present embodiment configured as described above, the interface between the non-polar liquid 150 and the polar liquid 160 is changed by the third electrode 133 together with the voltages applied to the first and second electrode 131 and 132 to control an incidence area of light incident from the light source unit 170. For example, light can be irradiated onto at least one of the color filters including the red color filter 111, the green color filter 112 and the blue color filter 113.

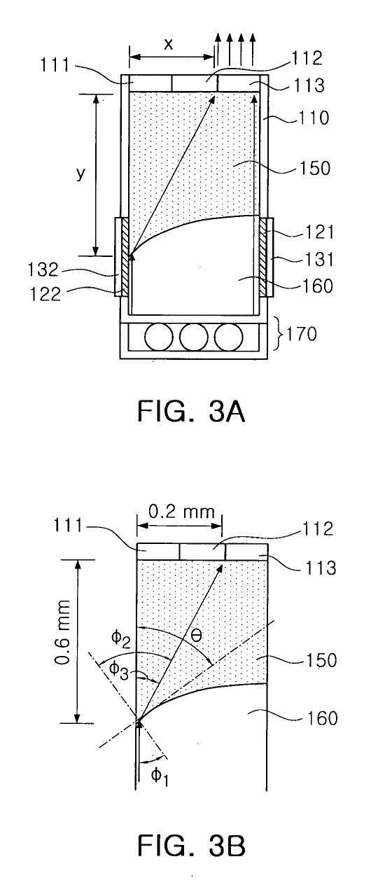

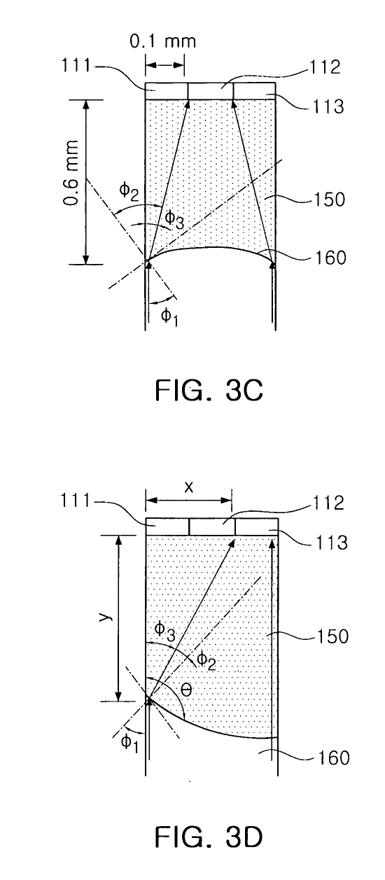

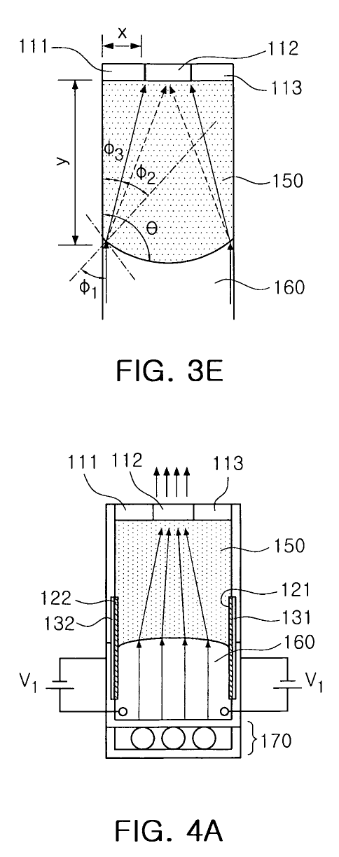

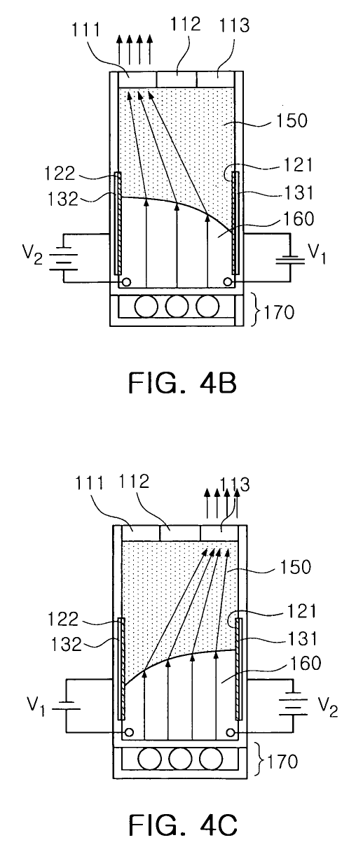

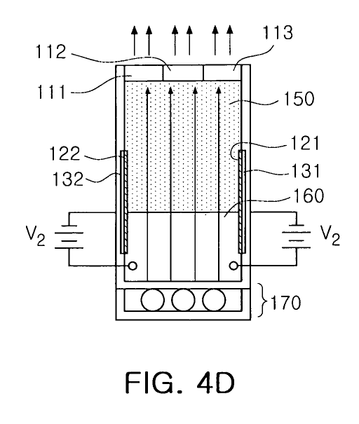

Hereinafter, with reference to FIGS. 3 and 4, a description will be given of a driving method of an optical driving apparatus 100 according to an exemplary embodiment of the invention, in which light incident from a light source unit 170 is irradiated onto at least one of the color filters by changing an interface between a non-polar liquid 150 and a polar liquid 160.

FIGS. 3A to 3E are explanatory views illustrating a driving principle of an optical driving apparatus using electrowetting according to an exemplary embodiment of the invention. FIGS. 4A to 4D illustrate a driving process of an optical driving apparatus using electrowetting according to an exemplary embodiment of the invention.

First, in the optical driving apparatus 100 of the present embodiment shown in FIG. 3A, a potential is generated in the polar liquid 160 by a third electrode (not shown) together with voltages applied to first and second electrodes 131 and 132. The potential generated changes an interface between the non-polar liquid 150 and the polar liquid 160 so that light incident from a light source unit 170 can be irradiated onto the blue color filter 113.

Specifically, in the optical driving apparatus 100 of the present embodiment, as a driving method for irradiating light incident from the light source unit 170 onto the blue color filter 113, as shown in FIG. 3B, the third electrode changes the interface between the non-polar liquid 150 and the polar liquid 160 together with the voltages applied to the first and second electrodes 131 and 132. Here, the interface between the non-polar liquid 150 and the polar liquid 160 is changed to have an interface angle (θ) with respect to the side walls of the cell housing 110.

For example, in a case where liquid droplets are present on a surface of a solid material, an interface between a solid and a liquid (SL), an interface between a liquid and a gas (LG), and an interface between a solid and a gas (SG) are formed. Among these, an interface angle between the liquid and the solid is determined according to respective surface tension coefficients and following Equation 1,

γ_{SL}−γ_{SG}=γ_{LG}·cos θ Equation 1,

where γ is respective surface tension coefficients.

Here, the solid in contact with the polar liquid 160 such as a conductive liquid is employed as an insulator and then the voltages are applied to the first and second electrodes 131 and 132 formed after the insulator to thereby change a surface tension coefficient. That is, Lippmann's Equation is defined according to following Equation 2:

$$γ = {γ}_{0} - \frac{1}{2} c {V}^{2} \qquad Equation 2$$

Under the Equation 2, the surface tension coefficient γ is changed according to the applied voltages V, and respective permittivity c of the polar liquid 160 and the insulator. Also, this surface tension coefficient changed by the voltages leads to a change in an interface angle (θ) and an irradiation angle (φ3).

Accordingly, the light irradiated onto the blue color filter 113 has the irradiation angle (φ3) with respect to the side walls of the cell housing 110 according to following Equations 3 and 4, respectively,

$$\begin{matrix}{φ}_{3} = {φ}_{2} - {φ}_{1} = {sin}^{- 1} ( \frac{{n}_{1}}{{n}_{2}} sin ( {φ}_{1} ) ) - {φ}_{1} , & Equation 3 \\ tan {φ}_{3} = \frac{x}{y} , & Equation 4\end{matrix}$$

where φ1 is an angle between the side walls of the cell housing 110 and a perpendicular normal line of the interface, φ2 is a refraction angle of light irradiated onto the blue color filter 113 with respect to the perpendicular normal line of the interface, φ3 is an irradiation angle of light refracted to the blue color filter 113 with respect to the side walls of the cell housing, n₁ is a refractivity of the polar liquid 160, n₂ is a refractivity of the non-polar liquid 150, x is a length from the side walls of the cell housing to a light irradiation area of the color filter, and y is a length from the red color filter 111 to the interface between the non-polar liquid 150 and the polar liquid 160 on the side walls of the cell housing.

For example, when x has a length of 0.2 mm, y has a length of 0.6 mm, the polar liquid 160 has a refractivity of 1.5, and the non-polar liquid 150 has a refractivity of 1.0, the irradiation angle φ3 is calculated to be 39.7 degrees.

Therefore, in order to irradiate the light incident from the light source unit 170 onto the blue color filter 113 at an angle of 39.7 degrees, different levels of voltages are applied to the first electrode 131 and the second electrode 132, respectively. Then, a potential is generated in the polar liquid 160 by the third electrode together with the voltages applied to the first and second electrodes 131 and 132 so that the interface between the non-polar liquid 150 and the polar liquid 160 is changed as in FIG. 3A. Accordingly, the light from the light source unit 170 passes through the non-polar liquid 150 and the polar liquid 160 whose interface has been changed, and then is irradiated onto the blue color filter 113.

FIG. 3C illustrates a driving method for irradiating the light onto the green color filter 112, in similar manner to what has been described above. When x has a length of 0.1 mm, y has a length of 0.6 mm, the polar liquid 160 has a refractivity of 1.5, and the non-polar liquid 150 has a refractivity of 1.0, the irradiation angles (φ3) with respect to both side walls of the cell housing 110 are calculated to be 29.8 degrees, respectively according to the above Equations 3 and 4.

Accordingly, the voltages applied to the first electrode 131 and the second electrode 132 are adjusted. Then, as shown in FIG. 3C, the third electrode changes the interface between the non-polar liquid 150 and the polar liquid 160 together with the voltages applied to the first and second electrodes 131 and 132. This allows the light incident from the light source unit 170 to be irradiated only onto the green color filter 112 at an irradiation angle (φ3) of 29.8 degrees.

Contrarily, as shown in FIG. 3D, the non-polar liquid 150 and the polar liquid 160 may be different in interface constant and the non-polar liquid 150 may have a refractivity greater than a refractivity of the polar liquid 160. In this case, to focus the light incident from the light source unit 170 and irradiate the light onto one of the blue color filter 113 and the green color filter 112, the interface between the non-polar liquid 150 and the polar liquid 160 should be shaped oppositely, i.e., curved downward. That is, the irradiation angle (φ3) satisfies following Equation 5,

$${φ}_{3} = {φ}_{1} - {φ}_{2} = {φ}_{1} - {sin}^{- 1} ( \frac{{n}_{1}}{{n}_{2}} sin ( {φ}_{1} ) ) , \qquad Equation 5$$

φ1 is an angle between the side walls of the cell housing 110 and a perpendicular normal line of the interface, φ2 is a refraction angle of light irradiated onto the blue color filter 113 with respect to the perpendicular normal line of the interface, φ3 is an irradiation angle of light refracted to the blue color filter 113 with respect to the side walls of the cell housing, n₁ is a refractivity of the polar liquid 160, n₂ is a refractivity of the non-polar liquid 150.

Referring to FIG. 3D, when the non-polar liquid 150 has a refractivity of e.g., 1.5, and the polar liquid 160 has a refractivity of 1.0, to irradiate the light onto the blue color filter 113, the interface angle (θ) between the non-polar liquid 150 and the polar liquid 160 is at least 138.3 degrees with respect to the side walls of the cell housing 110.

Also, as shown in FIG. 3E, when the non-polar liquid 150 has a refractivity of 1.5 and the polar liquid 160 has a refractivity of 1.0, to focus and irradiate the light from the light source unit 170 onto the green color filter 112 in a central portion, the light has an interface angle (θ) of 117.2 to 163 degrees with respect to the side walls of the cell housing.

Hereinafter, a driving process of an optical driving apparatus using electrowetting according to an exemplary embodiment of the invention will be described with reference to FIGS. 4A to 4D.

FIGS. 4A to 4D illustrate a driving process of an optical driving apparatus using electrowetting according to an exemplary embodiment of the invention.

As shown in FIG. 4A, in the optical driving apparatus using electrowetting according to the present embodiment, in order to focus and irradiate light incident from a light source unit 170 onto a green color filter in a central portion, voltages applied to a first electrode 131 and a second electrode 132 are adjusted to voltages V1 by a variable voltage device 140, respectively.

Accordingly, with the voltages V1 applied to the first electrode 131 and the second electrode 132, an interface between a non-polar liquid 150 and a polar liquid 160 is convexed upward by a third electrode formed on a portion of a bottom of a cell housing 110 to be in contact with the polar liquid 160. Thus, the light incident from the light source unit 170 can be irradiated onto only the green color filter 112 at an irradiation angle (φ3) of 29.8 degrees with respect to the side walls of the cell housing 110.

Moreover, as shown in FIGS. 4B and 4C, when the light from the light source unit 170 is focused and irradiated only onto the red color filter 111 or the blue color filter 113, the voltages applied to the first electrode 131 and the second electrode 132 may be applied as a voltage V1 and a voltage V2 greater than the voltage V1 by the variable voltage device 140, respectively.

Specifically, as shown in FIG. 4B, in order to focus and irradiate the light incident from the light source unit 170 onto the red color filter 111, the voltage V2 is applied to the second electrode 132 adjacent to the red color filter 111 and the voltage V1 is applied to the first electrode 131. Then, an interface between the non-polar liquid 150 and the polar liquid 160 is curved upward toward the second electrode 132 by the third electrode together with the voltages applied to the first and second electrodes 131 and 132. This curved interface between the non-polar liquid 150 and the polar liquid 160 allows the light incident from the light source unit 170 to be refracted and focused to be irradiated onto the red color filter 111.

Contrariwise, in order to focus and irradiate the light incident from the light source unit 170 onto the blue color filter 113, as shown in FIG. 4C, the voltage V1 is applied to the second electrode 132 adjacent to the red color filter 111 and the voltage V2 is applied to the first electrode 131. Then, an interface between the non-polar liquid 150 and the polar liquid 160 is curved upward toward the first electrode 131. As a result, the light incident from the light source unit 170 can be irradiated onto the blue color filter 113 by the interface between the non-polar liquid 150 and the polar liquid 160 curved upward toward the first electrode 131.

As described above, the light incident from the light source unit 170 can be focused and irradiated onto a predetermined one of the color filters 111, 112, and 113. Alternatively, as shown in FIG. 4D, to enable white light to be emitted selectively, the light incident from the light source unit 170 is irradiated evenly onto all of the color filters 111, 112, and 113 so that the light passed through the color filters 111, 112, and 113 can be emitted as white light.

As shown in FIG. 4D, in order to irradiate the light incident from the light source unit 170 evenly onto all of the color filters 111, 112, and 113, the identical levels of voltages V2, which are grater than the voltage V1 are applied to the first electrode 131 and the second electrode 132, respectively. Then, the interface between the non-polar liquid 150 and the polar liquid 160 is flattened by the third electrode together with the voltage V2.

Since the interface between the non-polar liquid 150 and the polar liquid 160 is formed as a plane not as a curve, the light incident from the light source unit 170 is evenly irradiated on to all of the color filters 111, 112, and 113. This allows the light passing through the color filters 111, 112, and 113 to be emitted as white light.

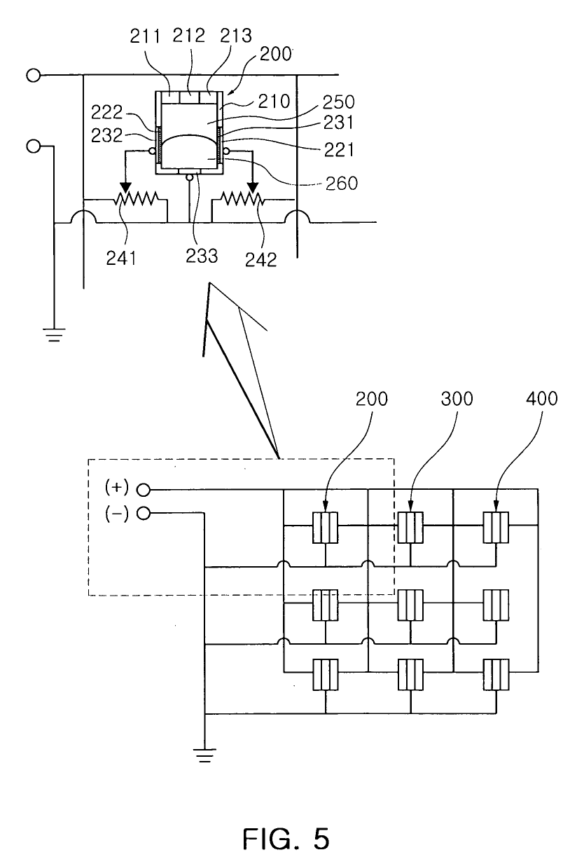

The optical driving apparatus using electrowetting according to the present embodiment may be provided in plural numbers to be employed in a backlight unit of a display apparatus. Accordingly, as shown in FIG. 5, a plurality of the optical driving apparatuses 200, 300, are 400 are arranged in connection with one another.

As shown in FIG. 5, in arranging the plurality of optical driving apparatuses 200, 300, and 400 using electrowetting according to an exemplary embodiment of the invention, a first variable resistor 241 is connected to a first electrode 231 and a second variable resistor 242 is connected to a second electrode 232, and a third electrode 233 is independently connected to allow the optical driving apparatuses 200, 300, and 400 to be connected in parallel with one another.

The optical driving apparatus 200 of the present embodiment is configured identically to the optical driving apparatus 100 of the previous embodiment except that the first variable resistor 241 is connected to the first electrode 231 and the second variable resistor 242 is connected to the second electrode 232.

The respective optical driving apparatuses 200, 300, and 400 according to the present embodiment are connected in parallel with one another. Also, in each of the optical driving apparatuses 200, 300, and 400, variable voltage devices such as variable resistors 241 and 242 are connected to the first electrode 231 and the second electrode 232, respectively. Accordingly, voltages are adjusted to levels identical to or different from each other by the variable resistors 241 and 242 to be applied to the first electrode 231 and the second electrode 232, respectively. Thus, a potential is generated in the polar liquid 260 by the third electrode disposed below the cell housing 110, together with the voltages applied to the first and second electrodes 231 and 232. The potential generated leads to a change in the interface between the non-polar liquid 250 and the polar liquid 260 and the changed interface allows the light to be irradiated onto a predetermined one of the color filters 211, 212, and 213.

Moreover, the plurality of optical driving apparatuses 200, 300, and 400 connected in parallel with one another as shown in FIG. 5 may be employed in other display apparatus to enable the light to be focused and irradiated.

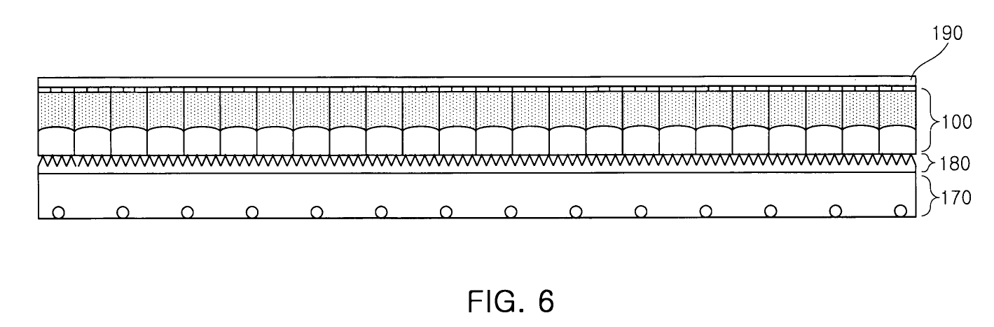

Specifically, the optical driving apparatus using electrowetting may be employed in a display apparatus according to another exemplary embodiment of the invention as shown in FIG. 6. Here, a plurality of optical driving apparatuses 100 of the present embodiment are disposed between a light source unit 170 and a light diffusion sheet 190. Then, as described above, light incident from the light source unit 170 through a prism sheet 180 is refracted and focused to be irradiated onto a predetermined one of color filters or all of the color filters. Then, the light is emitted to the light diffusion sheet 190.

As described above, in the display apparatus employing the plurality of optical driving apparatus according to the present embodiment of the invention, the light from the light source unit can be focused and irradiated onto the predetermined one of the color filters. This prevents occurrence of light loss associated with the conventional art when the light is transmitted to or blocked by the color filter. Accordingly, this enhances reliability of the display apparatus employing the optical driving apparatuses.

As set forth above, according to exemplary embodiments of the invention, an optical driving apparatus can focus and irradiate light from a light source unit onto a predetermined one of color filters. Thus, this eliminates a conventional problem of light loss which occurs when light is transmitted to or blocked by the color filter. This increases reliability of the display apparatus employing the optical driving apparatus.

While the present invention has been shown and described in connection with the exemplary embodiments, it will be apparent to those skilled in the art that modifications and variations can be made without departing from the spirit and scope of the invention as defined by the appended claims.

What is claimed is:

1. An optical driving apparatus comprising:
a cell housing housing a polar liquid and a non-polar liquid, the cell housing including side walls;
a first electrode formed on an outer surface of a first insulator formed on a portion of one of the side walls of the cell housing;
a second electrode formed on an outer surface of a second insulator formed on a portion of the other side wall of the cell housing;
a color filter formed on a top of the cell housing; and
a third electrode formed on a bottom of the cell housing to be in contact with the polar liquid so that the third electrode generates a potential in the polar liquid together with one of the first and second electrodes,
wherein light incident from a light source unit disposed below the third electrode is irradiated onto a predetermined area of the color filter.

2. The optical driving apparatus of claim 1, further comprising at least one variable voltage device electrically connected to one of the first and second electrodes,
wherein an interface between the polar liquid and the non-polar liquid is changed by the third electrode together with one of the first and second electrodes to which a voltage controlled by the variable voltage device is applied.

3. The optical driving apparatus of claim 1, wherein the cell housing has the side walls formed of a light blocking material and the bottom formed of a light transmitting material.

4. The optical driving apparatus of claim 1, wherein each of the first and second electrodes comprises a rectangular metal electrode formed on an outer side of the insulator along a corresponding one of the side walls of the cell housing.

5. The optical driving apparatus of claim 1, wherein the third electrode is formed of a transparent electrode material selected from a group consisting of ITO, ZnO, RuO₂, TiO₂ and IrO₂.

6. The optical driving apparatus of claim 2, wherein the variable voltage device is a variable resistor.

7. A method of driving an optical driving apparatus, the method comprising:
applying a voltage to one of first and second electrodes formed to oppose each other on both side walls of a cell housing, respectively, the cell housing housing a polar liquid and a non-polar liquid;
generating a potential in the polar liquid by a third electrode together with the voltage applied to one of the first and second electrodes, the third electrode formed on a bottom of the cell housing to be in contact with the polar liquid; and
irradiating light incident from a light source unit disposed below the third electrode onto a predetermined area of a color filter formed on a top of the cell housing by changing an interface between the polar liquid and the non-polar liquid according to the potential.

8. The method of claim 7, wherein the applying a voltage comprises forming the first and second electrodes on the both side walls of the cell housing to oppose each other,
wherein insulators are formed between each of the first and second electrodes and the cell housing, respectively.

9. The method of claim 7, wherein the applying a voltage comprises applying the voltage controlled by at least one variable voltage device electrically connected to one of the first and second electrodes.

10. The method of claim 7, wherein the irradiating light incident onto a predetermined area of a color filter comprises focusing and irradiating the light incident from the light source unit onto the predetermined area of the color filter through the changed interface between the non-polar liquid and the polar liquid.

11. The method of claim 7, wherein in the irradiating of the light incident onto the predetermined area of the color filter, the changed interface between the non-polar liquid and the polar liquid is curved upward toward the color filter, and an irradiation angle of the light irradiated onto the predetermined area of the color filter satisfies following Equations 3 and 4, respectively,
$$\begin{matrix}{φ}_{3} = {φ}_{2} - {φ}_{1} = {sin}^{- 1} ( \frac{{n}_{1}}{{n}_{2}} sin ( {φ}_{1} ) ) - {φ}_{1} , & Equation 3 \\ tan {φ}_{3} = \frac{x}{y} , & Equation 4\end{matrix}$$
where φ1 is an angle between the side walls of the cell housing and a perpendicular normal line of the interface, φ2 is a refraction angle of light irradiated onto the predetermined area of the color filter with respect to the perpendicular normal line of the interface, φ3 is an irradiation angle of light refracted to a light irradiation area with respect to the side walls of the cell housing, n₁ is a refractivity of the polar liquid, n₂ is a refractivity of the non-polar liquid, x is a length from the side walls of the cell housing to the light irradiation area of the color filter, and y is a length from the light irradiation area to the interface between the non-polar liquid and the polar liquid on the side walls of the cell housing.

12. The method of claim 7, wherein in the irradiating of the light incident onto the predetermined area of the color filter, the changed interface between the non-polar liquid and the polar liquid is curved upward toward the third electrode, and an irradiation angle of the light irradiated onto the predetermined area of the color filter satisfies following Equation 5,
$${φ}_{3} = {φ}_{1} - {φ}_{2} = {φ}_{1} - {sin}^{- 1} ( \frac{{n}_{1}}{{n}_{2}} sin ( {φ}_{1} ) ) , \qquad Equation 5$$
where φ1 is an angle between the side walls of the cell housing and a perpendicular normal line of the interface, φ2 is a refraction angle of light irradiated onto the predetermined area of the color filter with respect to the perpendicular normal line of the interface, φ3 is an irradiation angle of light refracted to a light irradiation area with respect to the side walls of the cell housing, n₁ is a refractivity of the polar liquid, n₂ is a refractivity of the non-polar liquid.

13. The method of claim 7, wherein the irradiating light incident onto a predetermined area of a color filter comprises irradiating the light incident from the light source unit onto an entire area of the color filter by flattening the changed interface between the polar liquid and the non-polar liquid.

14. The method of claim 7, wherein the cell housing has the side walls formed of a light blocking material and the bottom formed of a light transmitting material.

15. The method of claim 8, wherein each of the first and second electrodes comprises a rectangular metal electrode formed on an outer side of the insulator along a corresponding one of the side walls of the cell housing.

16. The method of claim 7, wherein the third electrode is formed of a transparent electrode material selected from a group consisting of ITO, ZnO, RuO₂, TiO₂ and IrO₂.

17. The method of claim 7, wherein the variable voltage device is a variable resistor.
